(19) United States
(12) Patent Application Publication
(10) Pub. No.: US 2026/0270132 A1
(43) Pub. Date: Sep. 10, 2026

(54) METHODS FOR SCHEDULING RESTRICTION EXTENSION FOR UPLINK (UL) TRANSMISSION IN A TIME DIVISION DUPLEX (TDD) BAND

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Saratoga, CA (US); Hong He, San Jose, CA (US); Haitong Sun, Cupertino, CA (US); Manasa Raghavan, Sunnyvale, CA (US); Xiang Chen, Campbell, CA (US); Herbert R. Dawid, Herzogenrath (DE); Andre Janssen, Meunchen (DE)

(21) Appl. No.: 18/993,621

(22) PCT Filed: Jul. 21, 2022
(86) PCT No.: PCT/CN2022/107019

§ 371 Date: Jan. 13, 2025

(51) Int. Cl. H04L 27/26; H04L 43/0817

(52) U.S. Cl. CPC H04L 27/2656; H04L 43/0817

(57) ABSTRACT

A user equipment (UE) includes a transceiver and a processor. The processor is configured to receive, in a time division duplex (TDD) band, a configuration for a serving cell signal that includes a plurality of symbols. The plurality of symbols corresponds to symbols of at least one synchronization signal block (SSB) for SSB-based radio resource management (RRM) measurement for a serving cell or a neighbor cell, and at least one symbol for uplink (UL) transmission. The processor is configured to, in response to determining that the relative position of the at least one symbol for the UL transmission is after a last symbol for the SSB-based RRM measurement in an SSB-based RRM measurement timing configuration (SMTC) window, restrict the UL transmission for a number of symbols that are after the last symbol of the symbols for the SSB-based RRM measurement in the SMTC window.

### TECHNICAL FIELD

This application relates generally to wireless communication systems, including methods and systems for scheduling restriction extension for uplink (UL) transmission in a time division duplex (TDD) band.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates example signals received at a user equipment (UE) from a serving cell and a neighbor cell, according to embodiments described herein.

FIG. 3 illustrates example signals received at a user equipment (UE) from a serving cell and a neighbor cell, with gap symbol(s) preceding a symbol for UL transmission, according to embodiments described herein.

FIG. 4 illustrates example signals received at a user equipment (UE) from a serving cell and a neighbor cell, including a signal received from the serving cell that includes a number of gap symbols preceding a symbol for UL transmission, according to embodiments described herein.

FIG. 5 illustrates an example flow-chart of operations that may be performed by a UE, according to embodiments described herein.

FIG. 6 illustrates an example flow-chart of operations that may be performed by a base station, according to embodiments described herein.

FIG. 7 illustrates an example flow-chart of operations that may be performed by a UE, according to embodiments described herein.

FIG. 8 illustrates an example architecture of a wireless communication system, according to embodiments described herein.

FIG. 9 illustrates a system for performing signaling between a wireless device and a network device, according to embodiments described herein.

### DETAILED DESCRIPTION

In the present disclosure, various embodiments are related to systems and methods for scheduling restriction for UL transmission in a time division duplex (TDD) band. In particular, the embodiments described herein are related to determining a number of gap symbols required to be sent to the UE for restricting UL transmission from the UE when a symbol for UL transmission is after a synchronization signal block (SSB) having symbols for the UE to perform measurements on the SSB symbols. Various embodiments described herein also relate to systems and methods for the UE to determine a number of symbols, which follows the SSB symbols on which the UE is to perform measurements, during which UL transmission from the UE is restricted.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

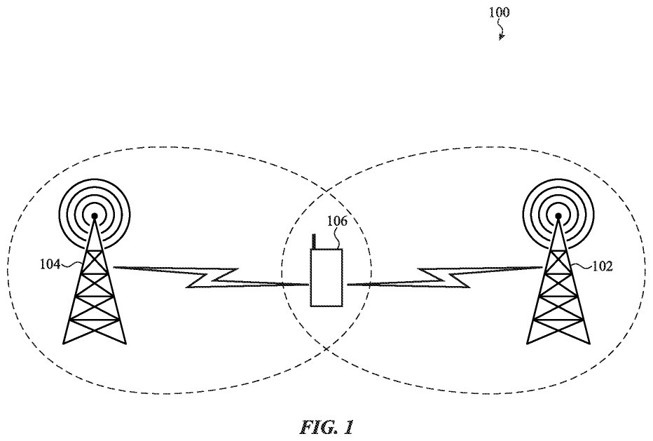

FIG. 1 shows an example wireless communication system, according to embodiments described herein. As shown in FIG. 1, a wireless communication system 100 may include base stations 102 and 104, and a UE 106. In some embodiments, the base stations 102 and 104 may be an eNb, an eNodeB, a gNodeB, or an access point (AP) in a radio access network (RAN) and may support one or more radio access technologies, such as 4G, 5G, 5G new radio (5G NR), and so on. The UE 106 may be a phone, a smart phone, a tablet, a smartwatch, an Internet-of-Things (IoT), and so on. By way of a non-limiting example, the UE 106 may be in a serving cell of the base station 102, and accordingly, a cell of the base station 104 may be a neighbor cell for the UE 106.

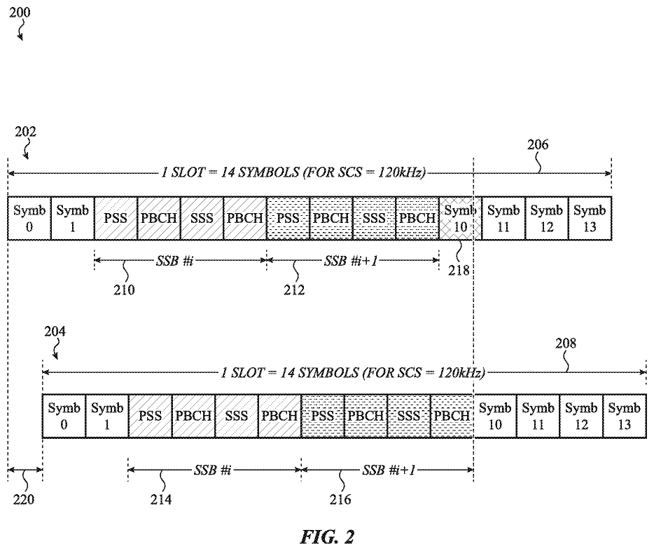

FIG. 2 illustrates example signals received at a user equipment (UE) from a serving cell and a neighbor cell. As shown in a diagram 200, the UE 106 may receive a signal 202 from its serving cell, and a signal 204 from its neighbor cell. A single slot 206 of the signal 202 from the serving cell of the UE 106, and a single slot 208 of the signal 204 from the neighbor cell of the UE may include 14 symbols for a subcarrier spacing of 120 kHz. While in the diagram 200, the signal 204 is shown to be received by the UE 106 as delayed by a propagation time difference shown as 220, depending on the UE 106's geographic location and other conditions, the signal 204 may be received by the UE 106 before the signal 202 with the propagation time difference 220.

In some embodiments, the signal 202 may include a first SSB, for example, SSB #i 210, and a second SSB, for example, SSB #i+1 212. The signal 204 may include a first SSB, for example, SSB #i 214, and a second SSB, for example, SSB #i+1 216. Each SSB of the SSBs 210, 212, 214, and/or 216 may include primary synchronization signal (PSS), secondary synchronization signal (SSS), and physical broadcast channel (PBCH) symbols. The UE 106 may perform measurements on the received SSB, for example, the SSB 210 and/or the SSB 212, for the serving cell, and the UE 106 may perform measurements on the received SSB, for example, the SSB 214 and/or the SSB 216, for the neighbor cell. Further, by way of a non-limiting example, a tenth symbol, for example, a symbol 218 is a symbol for the UE to perform UL transmission by the UE 106.

In some embodiments, measurements may include synchronization signal reference signal received power (SS-RSRP) measurements, synchronization signal to interference noise ratio (SS-SINR) measurements performed on the SSB symbols in a TDD band for frequency range-1 (FR1) and/or frequency range-2 (FR2). In some embodiments, measurements may include secondary synchronization signal reference signal received quality (SS-RSRQ) measurements performed on the SSB symbols and/or received signal strength indicator (RSSI) symbols in a TDD band for frequency range-1 (FR1) and/or frequency range-2 (FR2). By way of a non-limiting example, the measurements performed by the UE 106 may be intra-frequency measurements, and/or inter-frequency measurements. In some cases, the measurements performed by the UE 106 may be intra-RAT and/or inter-RAT measurements, and/or measurements performed in the UE 106's active bandwidth part (BWP) or other BWPs assigned to the UE 106. Further, measurements performed by the UE 106 may be on signals received at the UE by a serving cell of the UE 106 and/or a neighbor cell of the UE 106.

When the UE 106 performs the measurements described above, the UE 106 may not perform UL transmission of physical uplink control channel (PUCCH), physical uplink shared channel (PUSCH), and/or sounding reference signal (SRS) in the FRI and/or FR2, and/or may not perform downlink (DL) reception of physical downlink control channel (PDCCH), physical downlink shared channel (PDSCH), tracking reference signal (TRS), and/or channel state information reference signal (CSI-RS) for channel quality indicator (CQI) in the FR2.

Further, in the FRI and/or FR2, the UE may also not perform UL transmission of the PUCCH, PUSCH, and/or SRS on one data symbol before and one data symbol after each consecutive SSB symbols for UE measurements, for example, SS-RSRP and/or SS-SINR measurements, which are in an SSB measurement timing configuration (SMTC) window duration. In the FR1 and/or FR2, the UE may not perform UL transmission of the PUCCH, PUSCH, and/or SRS on one data symbol before and one data symbol after each consecutive SSB symbols and/or RSSI symbols for UE measurements, for example, SS-RSRQ measurements, which are in an SMTC window duration. In other words, UL transmission on the second symbol shown in the diagram 200 as symbol 1 for the signal 202, and the symbol 218 may not be used by the UE for UL transmission of PUCCH, PUSCH, and/or SRS. The symbol 218 may not be used by the UE for UL transmission because the symbol 218 has time overlapping with the last symbol of the SSB 216 of the signal 204 due to the propagation time difference 220. Accordingly, the UE 106 may still be performing measurements on the last symbol of the SSB 216 during some part of the symbol 218.

In the FR2, the UE may also not perform DL reception of the PDCCH, PDSCH, TRS, and/or CSI-RS for CQI on one data symbol before and one data symbol after each consecutive SSB symbols/RSSI symbols for UE measurements, for example, SS-RSRQ measurements, SS-RSRP and/or SS-SINR measurements, which are in an SMTC window duration.

An SMTC window described herein may correspond with periodicity and timing of the SSBs for the UE to perform cell quality measurements for a neighbor cell of the UE. If smtc2, which is a secondary measurement timing configuration for synchronization signal (SS) measurements with a physical cell id (PCI) listed in a PCI list, is configured by higher layer signaling as described in 3^{rd} Generation Partnership Project (3GPP) Technical Specification (TS) 38.331, the SMTC window duration (or periodicity) may follow smtc2, otherwise the SMTC window duration (or periodicity) may follow smtc1, which is a primary measurement timing configuration and provides timing offset and duration for SSB.

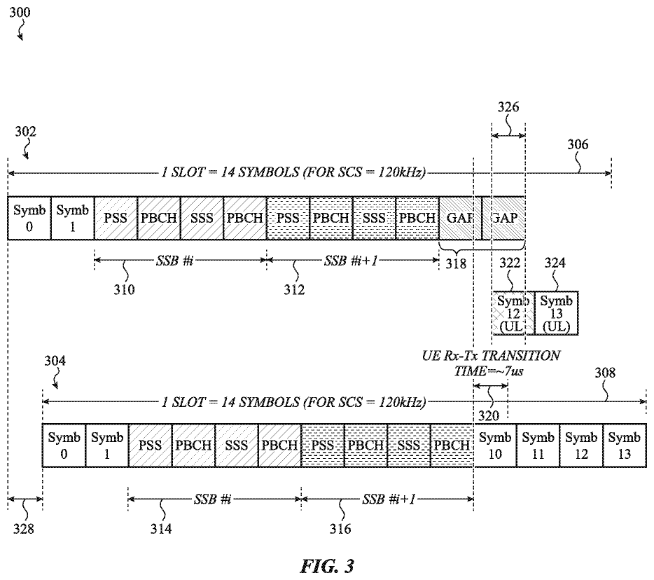

FIG. 3 illustrates example signals received at a user equipment (UE) from a serving cell and a neighbor cell with gap symbol(s) preceding a symbol for UL transmission. As shown in a diagram 300, the UE 106 may receive a signal 302 from its serving cell, and a signal 304 from its neighbor cell. A single slot 306 of the signal 302 from the serving cell of the UE 106, and a single slot 308 of the signal 304 from the neighbor cell of the UE 106 may include 14 symbols for a subcarrier spacing of 120 kHz. While in the diagram 300, the signal 304 is shown to be received by the UE 106 as delayed by a propagation time difference shown as 328, depending on the UE 106's geographic location and other conditions, the signal 304 may be received by the UE 106 before the signal 302 with the propagation time difference 328.

In some embodiments, the signal 302 may include a first SSB, for example, SSB #i 310, and a second SSB, for example, SSB #i+1 312. The signal 304 may include a first SSB, for example, SSB #i 314, and a second SSB, for example, SSB #i+1 316. Each SSB of the SSBs 310, 312, 314, and/or 316 may include primary synchronization signal (PSS), secondary synchronization signal (SSS), and physical broadcast channel (PBCH) symbols. The UE 106 may perform measurements on the received SSB, for example, the SSB 310 and/or the SSB 312, for the serving cell, and the UE 106 may perform measurements on the received SSB, for example, the SSB 314 and/or the SSB 316, for the neighbor cell. Further, by way of a non-limiting example, a tenth symbol and an eleventh symbol shown in the diagram 300 as 318 may be gap symbols, and a twelfth symbol and a thirteenth symbol shown in the diagram as 322 and 324, respectively, may be symbols to perform UL transmission by the UE 106.

As described herein, in accordance with some embodiments, the UE is restricted to perform UL transmission on symbols of SSB on which the UE is performing measurements described herein, and one data symbol before and after each consecutive SSB, such as SSBs 310, 312, 314, and 316. However, the signal 302 with the gap symbols 318 between the last symbol of the SSB 312 and the symbols for the UL transmission, the UE 106 may also be restricted to perform UL transmission during the gap symbols 318. Further, by way of a non-limiting example, the SSB 316 may have its last symbol partly or fully overlapping with only the first gap symbol of the gap symbols 318.

Accordingly, in some embodiments, the UE 106 may still not perform UL transmission, with timing advancement (TA), if the symbol 322 with the TA 326 still overlaps with Rx-to-Tx transition for the UE, which is shown as 320, and may be of 7 microseconds, the UE 106 may not use the symbol 322 for UL transmission. Alternatively, in some embodiments, the UE 106 may cancel performing measurements on the SSB 316.

Accordingly, for determining whether the UE can use a symbol allocated for UL transmission or not, the UE may need to check the UE's Rx-to-Tx transition time and TA information. The TA information may be based on TA info (N_{TA}) that is provided by a base station, such as a base station of the UE's serving cell, a neighbor cell, and/or core network, and a fixed offset value (N_{TA_Offset}), which may be 7 microseconds, for example.

In some embodiments, whether the UE can use a symbol allocated for UL transmission that is after a SSB may depend on determining a number of symbols from the last symbol of the SSB that cannot be used for performing UL transmission. The number of symbols from the last of the SSB that cannot be used may be determined based on any of the equation 1 or equation 2 shown below, which both may identify the same number of symbols that cannot be used for UL transmission. The Equation 1 and the Equation 2 below are based on a DL timeline. In the following equations, symbol_length represents a length of a symbol, which may be dependent upon a subcarrier spacing.

$$1 + ceiling ( ( {N}_{TA \_ Offset} ) / ( symbol\_length ) ) \qquad Equation 1$$

$$1 + ceiling ( ( {N}_{TA \_ Offset} + {N}_{TA} ) / ( symbol\_length ) ) \qquad Equation 2$$

In some embodiments, Equation 1 and/or Equation 2 may identify 2 symbols after the last symbols of the SSB that may not be used for UL transmission. As shown in FIG. 3, the symbol 322 with TA may overlap with 2 symbols after the last symbol of the SSB, and accordingly, the symbol 322 may not be used by the UE for UL transmission unless the UE cancels performing measurements on the SSB 316.

In some embodiments, whether the UE can use a symbol allocated for UL transmission that is after a SSB may depend on determining a number of symbols from the last symbol of the SSB that cannot be used for performing UL transmission. The number of symbols from the last of the SSB that cannot be used may be determined based on any of the equation 3 or equation 4 shown below, which both may identify the same number of symbols that cannot be used for UL transmission. The Equation 3 and the Equation 4 below are based on symbol index, when there is a gap symbol between an SSB and a symbol for UL transmission.

$$( ( symbol index of the last gap symbol - symbol index of the last symbol of the SSB ) + ceiling ( ( {N}_{TA \_ Offset} ) / ( symbol\_length ) ) ) \qquad Equation 3$$

$$( ( symbol index of the last gap symbol - symbol index of the last symbol of the SSB ) + ceiling ( ( {N}_{TA \_ Offset} + {N}_{TA} ) / ( symbol\_length ) ) ) \qquad Equation 4$$

In some embodiments, Equation 3 and/or Equation 4 may identify 3 symbols (when there are 2 gap symbols) after the last symbol of the SSB that may not be used for UL transmission. As shown in FIG. 3, a symbol index of the symbol 322 is 12, and a symbol index of the last symbol of the SSB is 9, the symbol 322 with symbol index 12 (9+3 (from Equation 3 or Equation 4)) may not be used by the UE for UL transmission unless the UE cancels performing measurements on the SSB 316 including a symbol with symbol index 9.

Accordingly, depending on whether a signal from the serving cell includes one or more gap symbols between the last symbol of the SSB and a symbol for UL transmission, as shown in the signal 202 and/or 302, the UE may determine whether the symbol for the UL transmission can be used for UL transmission or not using any of the Equation 1, Equation 2, Equation 3, or Equation 4.

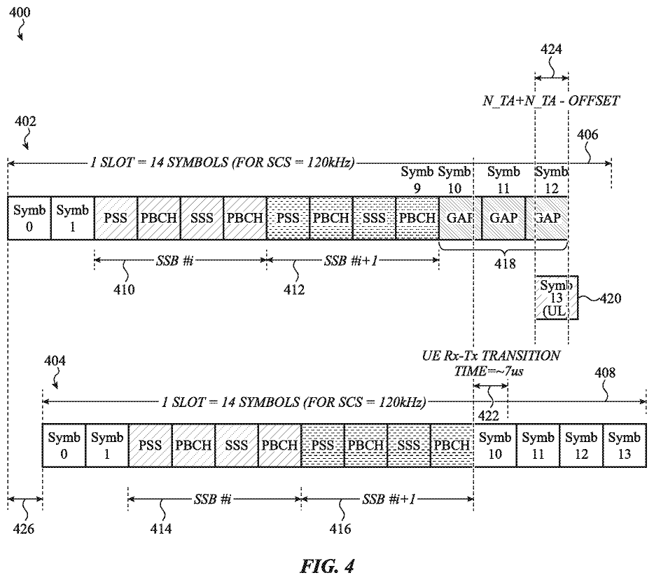

FIG. 4 illustrates example signals received at a user equipment (UE) from a serving cell and a neighbor cell, a signal from the serving cell including a number of gap symbols preceding a symbol for UL transmission, according to embodiments described herein. In particular, FIG. 4 describes in a diagram 400, a number of gap symbols that are required to be configured in a signal from a serving cell for a UE to prioritize intra-frequency SSB measurement without a measurement gap (MG) and optimize the scheduling restriction. In some embodiments, a minimum number of gap symbols required between the last symbol of the SSB and a symbol for UL transmission may be calculated by a network and/or a base station using Equation 5 or Equation 6 shown below.

$$2 + ceiling ( ( {N}_{TA \_ Offset} ) / ( symbol\_length ) ) \qquad Equation 5$$

$$2 + ceiling ( ( {N}_{TA \_ Offset} + {N}_{TA} ) / ( symbol\_length ) ) \qquad Equation 6$$

In some embodiments, the Equation 5 and the Equation 6 above may indicate that the minimum number of gap symbols required are 3.

As shown in a diagram 400, the UE 106 may receive a signal 402 from its serving cell, with a minimum number of gap symbols required as calculated based on Equation 5 or Equation 6, and a signal 404 from its neighbor cell. A single slot 406 of the signal 402 from the serving cell of the UE 106, and a single slot 408 of the signal 404 from the neighbor cell of the UE 106 may include 14 symbols for a subcarrier spacing of 120 kHz. While in the diagram 400, the signal 404 is shown to be received by the UE 106 as delayed by a propagation time difference shown as 426, depending on the UE 106's geographic location and other conditions, the signal 404 may be received by the UE 106 before the signal 402 with the propagation time difference 426.

In some embodiments, the signal 402 may include a first SSB, for example, SSB #i 410, and a second SSB, for example, SSB #i+1 412. The signal 404 may include a first SSB, for example, SSB #i 414, and a second SSB, for example, SSB #i+1 416. Each SSB of the SSBs 410, 412, 414, and/or 416 may include primary synchronization signal (PSS), secondary synchronization signal (SSS), and physical broadcast channel (PBCH) symbols. The UE 106 may perform measurements on the received SSB, for example, the SSB 410 and/or the SSB 412, for the serving cell, and the UE 106 may perform measurements on the received SSB, for example, the SSB 414 and/or the SSB 416, for the neighbor cell. Further, by way of a non-limiting example, a tenth symbol, an eleventh symbol, and a twelfth symbol shown in the diagram 400 as 418 may be gap symbols, and a thirteenth symbol shown in the diagram as 420 may be a symbol to perform UL transmission by the UE 106.

As described herein, in accordance with some embodiments, the UE is restricted to perform UL transmission on symbols of SSB on which the UE is performing measurements described herein, and one data symbol before and after each consecutive SSB, such as SSBs 410, 412, 414, and 416. However, the signal 402 with the gap symbols 418, the UE 106 may also be restricted to perform UL transmission during the gap symbols 418. However, as shown in the diagram 400, with three gap symbols between the last symbol of the SSB 412 and the symbol 420 for the UL transmission, even with the timing advancement for UL transmission 424 and UE's Rx-to-Tx transition time 422, the symbol for UL transmission does not overlap with the last symbol of the SSB 416. Thus, intra-frequency measurements may be prioritized without loss or unuse of a symbol for UL transmission. Accordingly, scheduling for UL transmission can be optimized based on various embodiments, as described herein.

In some embodiments, in a TDD band, a UE may prioritize SSB measurements without measurement gap and introducing interruption allowance. By way of a non-limiting example, if a symbol after SSB is for scheduling UL transmission, the UE may disable or mute UL transmission to the serving cell earlier than a predetermined number of symbols (for example, 0, 1, or 2 symbols) plus N_Rx-TX after the end of the last received downlink SSB symbol from the serving cell in the TDD band. N_Rx-Tx is the UE's Rx-to-Tx switching time, and which may be 7 microseconds or 13 microseconds, depending on the frequency range.

In some embodiments, if a symbol after SSB is for scheduling UL transmission, and a predetermined number of symbols (for example, 0, 1, or 2 symbols) plus (N_Rx-TX+N_{TA_Offset}+N_{TA}) is greater than or equal to the gap symbols after the end of the last received downlink SSB symbol from the serving cell in the TDD band, and the symbol for UL transmission, the UE may disable or mute UL transmission for (ceiling((N_Rx-Tx+N_{TA_Offset}+N_{TA})/(symbol_length))+x), where x is 0, 1, or 2 symbols.)

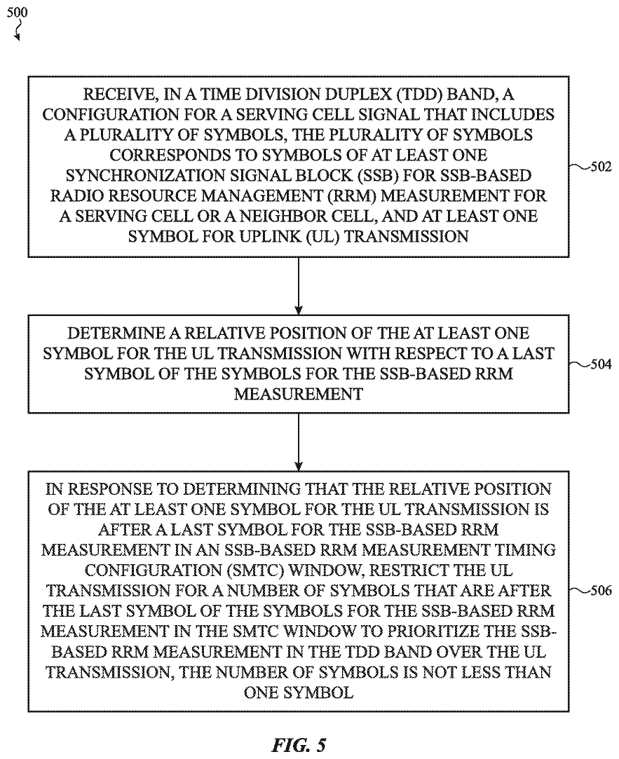

FIG. 5 illustrates an example flow-chart of operations that may be performed by a UE, according to embodiments described herein. As shown in a flow-chart 500, at 502, a UE may receive from a base station of its serving cell, a configuration of a serving cell signal, such as the signal 202, the signal 302, and/or the signal 402. The serving cell signal 202, 302, and/or 402 may include a plurality of symbols that corresponds to symbols of at least one SSB for SSB-based radio resource management (RRM) measurement for a serving cell or a neighbor cell, and at least one symbol for UL transmission. Accordingly, in some embodiments, there may be two SSBs for RRM measurement, and the two SSBs may be consecutive.

In some embodiments, the plurality of symbols may include at least one gap symbol between the SSB and the at least one symbol for UL transmission.

At 504, the UE may determine a relative position of the at least one symbol for the UL transmission with respect to a last symbol for the SSB-based RRM measurement. Accordingly, if there are two SSBs for RRM measurement, the UE may determine a relative of the at least one symbol for the UL transmission with the last symbol of the last SSB. In the present disclosure, a relative position refers to a relative timeline position.

At 506, in response to determining that the relative position of the at least one symbol for the UL transmission with respect to the last symbol for the SSB-based RRM measurement is after the last symbol for the SSB-based RRM measurement in an SSB-based RRM measurement timing configuration window (SMTC) window, the UE may restrict the UL transmission for a number of symbols that are after the last symbol for the SSB-based RRM measurement in the SMTC window to prioritize the SSB-based measurement in the TDD band over the UL transmission. The number of symbols may be determined using any of the Equation 1, Equation 2, Equation 3, or Equation 4, described herein, in accordance with some embodiments. Accordingly, the number of symbols after the last symbol for the SSB-based RRM measurement may be at least 2 or not less than 1.

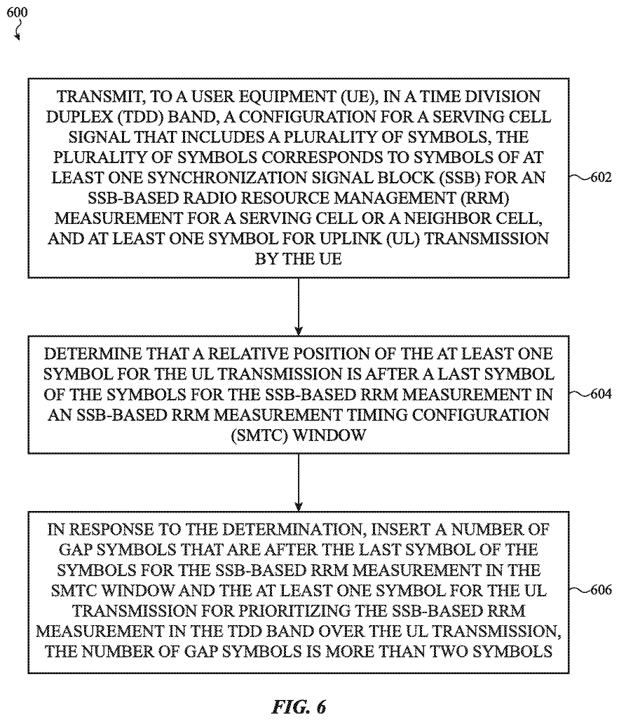

FIG. 6 illustrates an example flow-chart of operations that may be performed by a base station, according to embodiments described herein. As shown in a flow-chart 600, at 602, a base station may transmit to a UE in its serving cell, a configuration of a serving cell signal, such as the signal 202, the signal 302, and/or the signal 402. The serving cell signal 202, 302, and/or 402 may include a plurality of symbols that corresponds to symbols of at least one SSB for SSB-based radio resource management (RRM) measurements for a serving cell or a neighbor cell, and at least one symbol for UL transmission. Accordingly, in some embodiments, there may be two SSBs for RRM measurement, and the two SSBs may be consecutive.

At 604, the base station may determine a relative position of the at least one symbol for the UL transmission with respect to a last symbol for the SSB-based RRM measurement. Accordingly, if there are two SSBs for RRM measurement, the UE may determine a relative position of the at least one symbol for the UL transmission with the last symbol of the last SSB. At 606, in response to determining that the relative position of the at least one symbol for the UL transmission with respect to the last symbol for the SSB-based RRM measurement is after the last symbol for the SSB-based RRM measurement in an SSB-based RRM measurement timing configuration window (SMTC) window, the base station may insert a number of gap symbols that are after the last symbol for the SSB-based RRM measurement in the SMTC window to prioritize the SSB-based measurement in the TDD band over the UL transmission. The number of gap symbols may be determined using any of the Equation 5, or Equation 6, described herein, in accordance with some embodiments. Accordingly, the number of gap symbols after the last symbol for the SSB-based RRM measurement may be at least 3 or more than two.

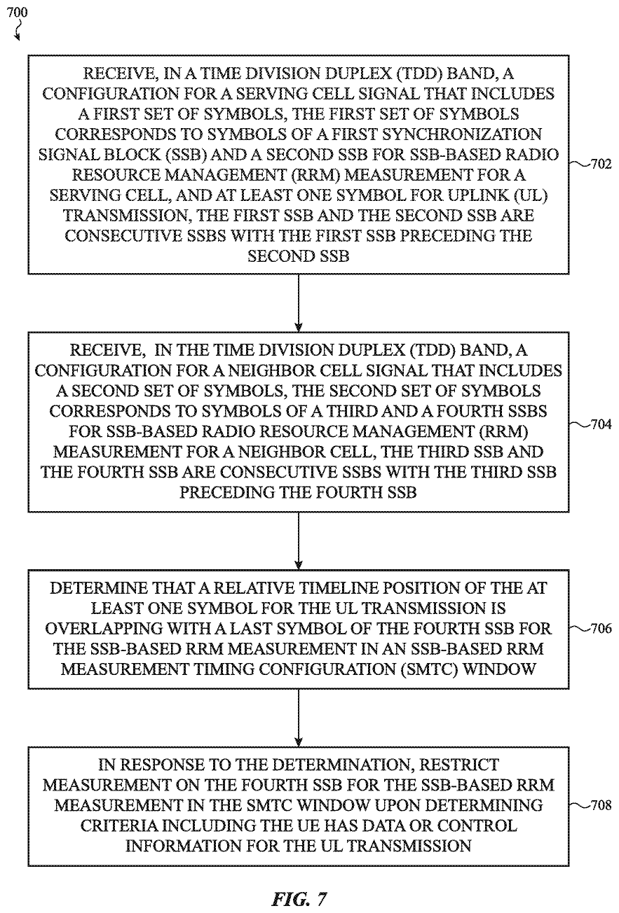

FIG. 7 illustrates an example flow-chart of operations that may be performed by a UE, according to embodiments described herein. As shown in a flow-chart 700, at 702, a UE may receive from a base station of its serving cell, a configuration of a serving cell signal, such as the signal 202, the signal 302, and/or the signal 402. The serving cell signal 202, 302, and/or 402 may include a first set of symbols that corresponds to symbols of a first SSB and a second SSB for SSB-based radio resource management (RRM) measurement for a serving cell, and at least one symbol for UL transmission. Accordingly, in some embodiments, the first SSB and the second SSB may be consecutive SSBs. In some embodiments, the plurality of symbols may include at least one gap symbol between the SSB and the at least one symbol for UL transmission.

At 704, the UE may receive from a base station of its neighbor cell, a configuration for a neighbor cell signal, such as the signal 204, the signal 304, and/or the signal 404. The neighbor cell signal 204, 304, and/or 404 may include a second set of symbols that corresponds to symbols of a third SSB and a fourth SSB for SSB-based radio resource management (RRM) measurement for a neighbor cell. In some embodiments, the third SSB and the fourth SSB may be consecutive SSBs.

At 706, to the UE may determine whether a relative timeline position of the at least one symbol for the UL transmission is overlapping with a last symbol of the fourth SSB for the SSB-based RRM measurement in an SSB-based RRM measurement timing configuration (SMTC) window. At 708, in response to the determination that the last symbol of the fourth SSB and the at least one symbol for the UL transmission are overlapping in time, the UE may cancel or restrict measurement on the symbols of the fourth SSB in the SMTC window upon determining that the UE has data or control information waiting for UL transmission. In other words, the UE may prioritize UL transmission over the intra-band RRM measurement in some conditions, such as high priority data or control information that is to be transmitted in the UL direction.

In some embodiments, the UE may prioritize UL transmission over the intra-band RRM measurements, when the UE determines that a number of gap symbols after the last symbol of the second SSB and the at least one symbol for the UL transmission is less that a minimum number of gap symbols according to Equation 5 or Equation 6.

Embodiments contemplated herein include an apparatus having means to perform one or more elements of the method 500, 600, or 700. In the context of method 500, or 700, this apparatus may be, for example, an apparatus of a UE (such as a wireless device 902 that is a UE, as described herein). In the context of method 600, this apparatus may be, for example, an apparatus of a base station (such as a network device 920 that is a base station, as described herein).

Embodiments contemplated herein include one or more non-transitory computer-readable media storing instructions to cause an electronic device, upon execution of the instructions by one or more processors of the electronic device, to perform one or more elements of the method 500, 600, or 700. In the context of method 500, or 700, this non-transitory computer-readable media may be, for example, a memory of a UE (such as a memory 906 of a wireless device 902 that is a UE, as described herein). In the context of method 600, this non-transitory computer-readable media may be, for example, a memory of a base station (such as a memory 924 of a network device 920 that is a base station, as described herein).

Embodiments contemplated herein include an apparatus having logic, modules, or circuitry to perform one or more elements of the method 500, 600, or 700. In the context of method 500, or 700, this apparatus may be, for example, an apparatus of a UE (such as a wireless device 902 that is a UE, as described herein). In the context of method 600, this apparatus may be, for example, an apparatus of a base station (such as a network device 920 that is a base station, as described herein).

Embodiments contemplated herein include an apparatus having one or more processors and one or more computer-readable media, using or storing instructions that, when executed by the one or more processors, cause the one or more processors to perform one or more elements of the method 500, 600, or 700. In the context of method 500, or 700, this apparatus may be, for example, an apparatus of a UE (such as a wireless device 902 that is a UE, as described herein). In the context of the method 600, this apparatus may be, for example, an apparatus of a base station (such as a network device 920 that is a base station, as described herein).

Embodiments contemplated herein include a signal as described in or related to one or more elements of the method 500, 600, or 700.

Embodiments contemplated herein include a computer program or computer program product having instructions, wherein execution of the program by a processor causes the processor to carry out one or more elements of the method 500, 600, or 700. In the context of method 500, or 700, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 600, the processor may be a processor of a base station (such as a processor(s) 922 of a network device 920 that is a base station, as described herein), and the instructions may be, for example, located in the processor and/or on a memory of the base station (such as a memory 924 of a network device 920 that is a base station, as described herein).

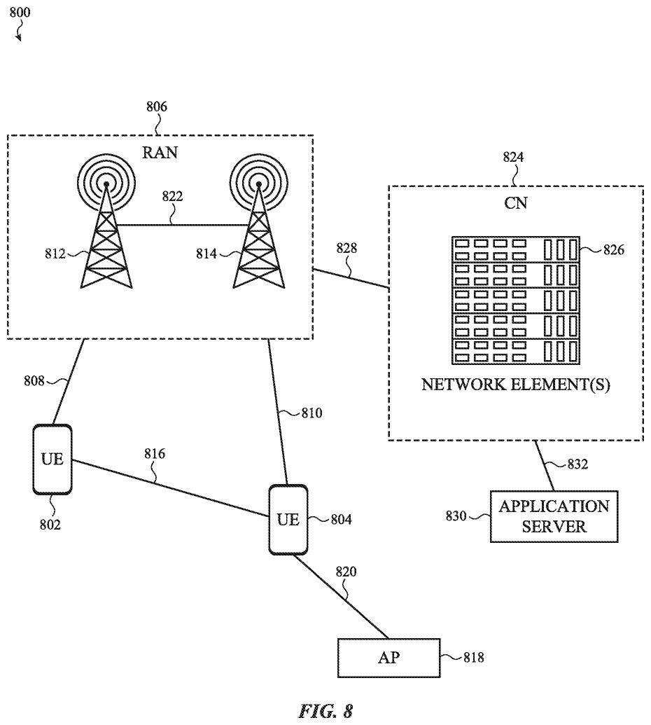

FIG. 8 illustrates an example architecture of a wireless communication system, according to embodiments described herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

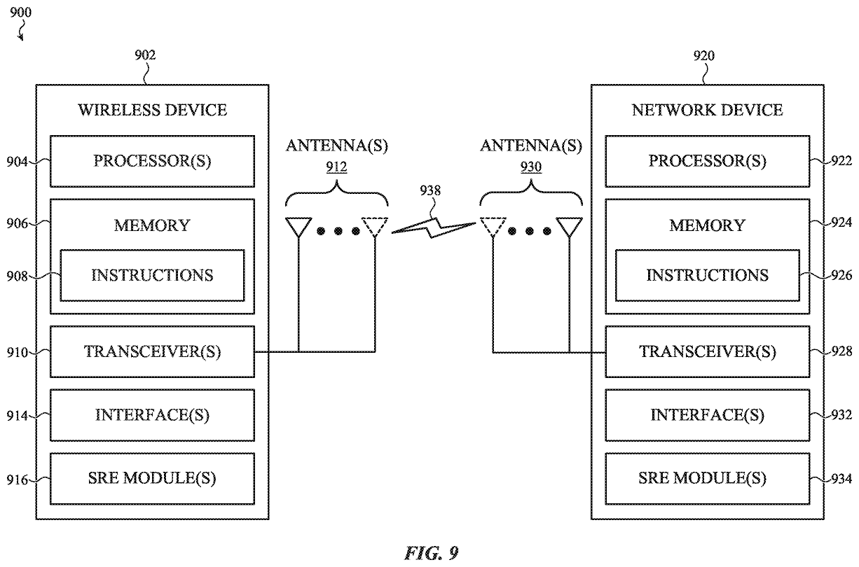

FIG. 9 illustrates a system 900 for performing signaling 938 between a wireless device 902 and a network device 920, according to embodiments described herein. The system 900 may be a portion of a wireless communication system as herein described. The wireless device 902 may be, for example, a UE of a wireless communication system. The network device 920 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a scheduling restriction extension module 916. The scheduling restriction extension (SRE) module 916 may be implemented via hardware, software, or combinations thereof. For example, the scheduling restriction extension module 916 may be implemented as a processor, circuit, and/or instructions 908 stored in the memory 906 and executed by the processor(s) 904. In some examples, the scheduling restriction extension module 916 may be integrated within the processor(s) 904 and/or the transceiver(s) 910. For example, the scheduling restriction extension module 916 may be implemented by a combination of software components (e.g., executed by a DSP or a general processor) and hardware components (e.g., logic gates and circuitry) within the processor(s) 904 or the transceiver(s) 910.

The scheduling restriction extension module 916 may be used for various aspects of the present disclosure, for example, aspects of FIGS. 2-5 and 7, from the UE perspective.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include a scheduling restriction extension (SRE) module 934. The scheduling restriction extension module 934 may be implemented via hardware, software, or combinations thereof. For example, the scheduling restriction extension module 934 may be implemented as a processor, circuit, and/or instructions 926 stored in the memory 924 and executed by the processor(s) 922. In some examples, the scheduling restriction extension module 934 may be integrated within the processor(s) 922 and/or the transceiver(s) 928. For example, the scheduling restriction extension module 934 may be implemented by a combination of software components (e.g., executed by a DSP or a general processor) and hardware components (e.g., logic gates and circuitry) within the processor(s) 922 or the transceiver(s) 928.

The scheduling restriction extension module 934 may be used for various aspects of the present disclosure, for example, aspects of FIGS. 2-4 and 6, from a base station perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
receive, at the UE, via the transceiver, in a time division duplex (TDD) band, a configuration for a serving cell signal that includes a plurality of symbols, the plurality of symbols corresponds to symbols of at least one synchronization signal block (SSB) for SSB-based radio resource management (RRM) measurement for a serving cell or a neighbor cell, and at least one symbol for uplink (UL) transmission;
determine a relative position of the at least one symbol for the UL transmission with respect to a last symbol of the symbols for the SSB-based RRM measurement; and
in response to determining that the relative position of the at least one symbol for the UL transmission is after a last symbol for the SSB-based RRM measurement in an SSB-based RRM measurement timing configuration (SMTC) window:
restrict the UL transmission for a number of symbols that are after the last symbol of the symbols for the SSB-based RRM measurement in the SMTC window to prioritize the SSB-based RRM measurement in the TDD band over the UL transmission, the number of symbols is not less than one symbol.

2. The UE of claim 1, wherein the plurality of symbols corresponds to the symbols of at least two consecutive SSBs for the SSB-based RRM measurement for the serving cell or the neighbor cell.

3. The UE of claim 1, wherein the plurality of symbols further includes at least one gap symbol positioned consecutively after the last symbol of the symbols for the SSB-based RRM measurement and the at least one symbol for the UL transmission.

4. The UE of claim 1, wherein:
the particular number of symbols is at least two symbols; and
the processor is configured to determine the particular number of symbols based on at least:
a fixed timing advance offset (N_{TA_Offset}); and
a length of a symbol of the plurality of symbols (symbol_length).

5. The UE of claim 4, wherein the processor is configured to determine the particular number of symbols further based on:
a total count of gap symbols after the last symbol of the symbols for the SSB based RRM measurement in the SMTC window (number_of_gap_symbols); and
a timing advance value sent to the UE by the serving cell (N_{TA}).

6. The UE of claim 1, wherein:
the processor is configured to determine the number of symbols based on an equation that is (1+celiling((N_{TA_Offset})/(symbol_length))); and
the N_{TA_Offset} corresponds with a fixed timing advance offset, and the symbol_length corresponds with a length of a symbol of the plurality of symbols.

7. The UE of claim 1, wherein:
the processor is configured to determine the number of symbols based on an equation that is (number_of_gap_symbols+ceiling ((N_{TA_Offset})/(symbol_length))); and
the N_{TA_Offset} corresponds with a fixed timing advance offset, the symbol_length corresponds with a length of a symbol of the plurality of symbols, and the number_of_gap_symbols corresponds with a total count of gap symbols after the last symbol of the symbols for the SSB-based RRM measurement in the SMTC window.

8. The UE of claim 7, wherein the total count of gap symbols after the last symbol of the symbols for the SSB-based RRM measurement in the SMTC window is at least two.

9. The UE of claim 1, wherein:
the processor is configured to determine the number of symbols based on an equation that is (1+celiling((N_{TA_Offset}+N_{TA})/(symbol_length))); and
the N_{TA_Offset} corresponds with a fixed timing advance offset, the symbol_length corresponds with a length of a symbol of the plurality of symbols, and the N_{TA} corresponds with a timing advance value sent to the UE by the serving cell.

10. The UE of claim 1, wherein:
the processor is configured to determine the number of symbols based on an equation that is (number_of_gap_symbols+ceiling (N_{TA_Offset}+N_{TA})/(symbol_length); and
the N_{TA_Offset} corresponds with a fixed timing advance offset, the symbol_length corresponds with a length of a symbol of the plurality of symbols, the number_of_gap_symbols corresponds with a total count of gap symbols after the last symbol of the symbols for the SSB-based RRM measurement in the SMTC window, and the N_{TA} corresponds with a timing advance value sent to the UE by the serving cell.

11. The UE of claim 1, wherein the processor is configured to:
determine the number of symbols based on two of more of:
a fixed number of symbols;
a Rx-to-Tx switching time of the UE (N_Rx-to-Tx);
N_{TA_Offset} that corresponds with a fixed timing advance offset; and
N_{TA} corresponds with a timing advance value sent to the UE by the serving cell.

12. The UE of claim 11, wherein the fixed number of symbols is predetermined, or received by the UE from the serving cell.

13. The UE of claim 11, wherein the fixed number of symbols corresponds to data symbols or SSB symbols.

14. The UE of claim 11, wherein the N_Rx-to-Tx is represented as a number of symbols, or a time in microseconds.

15. A base station, comprising:
a transceiver; and
a processor configured to:
transmit, to a user equipment (UE), via the transceiver, in a time division duplex (TDD) band, a configuration for a serving cell signal that includes a plurality of symbols, the plurality of symbols corresponds to symbols of at least one synchronization signal block (SSB) for an SSB-based radio resource management (RRM) measurement for a serving cell or a neighbor cell, and at least one symbol for uplink (UL) transmission by the UE;
determine that a relative position of the at least one symbol for the UL transmission is after a last symbol of the symbols for the SSB-based RRM measurement in an SSB-based RRM measurement timing configuration (SMTC) window;
in response to the determination,
insert a number of gap symbols that are after the last symbol of the symbols for the SSB-based RRM measurement in the SMTC window and the at least one symbol for the UL transmission for prioritizing the SSB-based RRM measurement in the TDD band over the UL transmission, the number of gap symbols is more than two symbols.

16. The base station of claim 15, wherein the processor is configured to determine the number of gap symbols based on an equation that is (2+celiling((N_{TA_Offset})/(symbol_length))); and
the N_{TA_Offset} corresponds with a fixed timing advance offset, and the symbol_length corresponds with a length of a symbol of the plurality of symbols.

17. The base station of claim 15, wherein the processor is configured to determine the number of gap symbols based on an equation that is (2+ceiling((N_{TA_Offset}+N_{TA})/(symbol_length))); and
the N_{TA_Offset} corresponds with a fixed timing advance offset, the symbol_length corresponds with a length of a symbol of the plurality of symbols, and the N_{TA} corresponds with a timing advance value sent to the UE by the serving cell.

18. A user equipment (UE), comprising:
a transceiver; and
a processor configured to:
receive, at the UE, via the transceiver, in a time division duplex (TDD) band, a configuration for a serving cell signal that includes a first set of symbols, the first set of symbols corresponds to symbols of a first synchronization signal block (SSB) and a second SSB for SSB-based radio resource management (RRM) measurement for a serving cell, and at least one symbol for uplink (UL) transmission, the first SSB and the second SSB are consecutive SSBs with the first SSB preceding the second SSB;
receive, at the UE, via the transceiver, in the time division duplex (TDD) band, a configuration for a neighbor cell signal that includes a second set of symbols, the second set of symbols corresponds to symbols of a third and a fourth SSBs for SSB-based radio resource management (RRM) measurement for a neighbor cell, the third SSB and the fourth SSB are consecutive SSBs with the third SSB preceding the fourth SSB;
determine that a relative timeline position of the at least one symbol for the UL transmission is overlapping with a last symbol of the fourth SSB for the SSB-based RRM measurement in an SSB-based RRM measurement timing configuration (SMTC) window;
in response to the determination,
restrict measurement on the fourth SSB for the SSB-based RRM measurement in the SMTC window upon determining criteria including the UE has data or control information for the UL transmission.

19. The UE of claim 18, wherein the criteria further includes a total number of gap symbols after the last symbol of the second SSB and before the at least one symbol for the UL transmission is less than a predetermined number of gap symbols.

20. The UE of claim 19, wherein:
the number of gap symbols is determined based on an equation that is one of
(2+celiling ((N_{TA_Offset})/(symbol_length))), or (2+ceiling((N_{TA_Offset}+N_{TA})/(symbol_length))); and
the N_{TA_Offset} corresponds with a fixed timing advance offset, the symbol_length corresponds with a length of a symbol of the plurality of symbols, and the N_{TA} corresponds with a timing advance value sent to the UE by the serving cell.
